(19) United States
(12) Patent Application Publication
(10) Pub. No.: US 2006/0250042 A1
(43) Pub. Date: Nov. 9, 2006

(54) Dynamoelectric machine with ring type rotor and stator windings

(76) Inventors: Kirk Neet, Saline, MI (US); Dave Smith, Grabill, IN (US)

Correspondence Address: KIRK NEET, 361 DOGWOOD CT., SALINE, MI, 48176, US

(21) Appl. No.: 11/124,663

(22) Filed: May 9, 2005

(51) Int. Cl. H02K 37/14; H02K 19/00; H02K 17/00

(52) U.S. Cl. 310/164; 310/49 R; 310/166; 310/114

(57) ABSTRACT

A stator and rotor assembly of a dynamoelectric machine wherein the stator core of the stator assembly includes a plurality of stator ring slots and the rotor assembly includes a plurality of rotor ring slots. The stator assembly further includes a conductor disposed in each stator ring slot having a plurality of full revolutions around the central axis of the stator core. The rotor assembly further including a rotor conductor disposed in each rotor ring slot having a plurality of full revolutions around the central axis of the rotor assembly. The stator core and rotor assembly both include tooth portions to direct the flux produced by the rotor conductor around the stator in the proper manner to induce the desired generated voltage in each stator conductor, thereby enabling each conductor to have the desired phase angle.

### FIELD OF THE INVENTION

The invention relates to concentric stator and rotor winding configurations for dynamoelectric machines, such as an automotive electrical alternator.

### BACKGROUND OF THE INVENTION

Dynamoelectric machines such as electrical alternators adapted for use in motor vehicle applications typically include a rotor assembly rotatable within an annular stator. Typical rotor pole pieces, which may preferably be of an interleaved “claw pole” design, rotate with the rotor shaft, while the typical stator itself includes a stator core defining radially-extending slots in which a plurality of stator windings are disposed. An excitation winding is carried within the cavity formed between pole pieces of the rotor, and a DC signal is applied to the excitation winding through a pair of slip rings and associated brushes. The magnetic field produced by the winding interacts with the pole pieces to create an alternating polarity magnetic field which, upon rotation of the rotor assembly as driven by the vehicle's engine, induces current flow in the stator windings in a known manner. The term alternator includes any dynamoelectric machine that is used to convert mechanical energy into electrical energy to charge a battery and therefore includes a starter-alternator type machine. Although described as an alternator, the present invention could also be used as a motor or generator.

The resistance of the rotor winding is an important factor for improving alternator electrical output because it determines the amount of current flow in the rotor winding for a given voltage and therefore is an important factor in determining the amount of magnetic flux produced by the rotor. The typical “claw pole” rotor assembly has a low “slot fill factor” and therefore high resistance due to the following reasons; the cross section of the conductor is typically round, the spacing in between the poles for the winding is difficult to fill with a winding because the space has an irregular shape and it is difficult to achieve a perfect layered wind for each rotor.

The air gap between the rotor outer diameter and the stator inner diameter of the typical alternator designs is relatively large. A large air gap is undesirable because air does not transmit flux efficiently and therefore reduces the amount of flux produced by the rotor. The air gap of the typical alternator designs is large because the pole fingers of the “claw-pole” design are relatively flexible and tend to bend outwards at high rotor rotational speeds due to the centrifugal force and therefore, the air gap is required to be relatively large so that the pole fingers do not interfere with the stator under these centrifugal loads.

As a rotor pole passes by a stationary stator pole, the flux on the surface of the rotor poles changes quickly and therefore the pole surface exhibits an eddy current loss. An eddy current loss increases the alternator losses and therefore reduces the efficiency of the typical alternator. It is known in the art that a laminated material reduces the eddy current losses but the shape of the typical “claw-pole” rotor poles does not allow the surface of the rotor poles to be easily laminated.

To increase the output of a machine it is desirable to increase the axial length of the rotor. An increased rotor length of the typical “claw-pole” rotor, however, increases the amount of the bending described in the previous paragraph and also increases the amount of axial flow of the flux in the stator core. Flux flow in the axial direction is undesirable because; one, axial flux flow increases the length of the flux path and thereby reducing the amount of flux and two, the stator is not easily laminated in the axial direction and therefore the eddy current looses are increased and the efficiency is reduced.

The resistance of the stator winding is an important factor for improving alternator electrical output and overall stator size because the resistance of the conductors of the stator windings is inversely proportional to alternator output and efficiency. To achieve higher electrical outputs while reducing the overall size of the stator, the prior art has, therefore, sought to employ stator conductors of square or rectangular cross-section to reduce the inherent resistance of the conductors. Such conductors can be placed into the stator core slots in a very densely packed configuration, thereby improving the “slot fill factor” and thereby resulting in a low stator winding resistance. The typical stator winding includes conductors which include a series of slot segments which are interconnected by end loop segments that project axially from either end of the core. Each slot segment is disposed axially in respective core slots of the stator core and typically extends the complete axial length of the stator core. The slot segments, especially slot segments which extend the complete length of the core, are undesirable in that they increase the length of each conductor and therefore, increase the resistance of each conductor. Furthermore, the typical alternator stator has a relationship wherein the number of core slots in a stator core is a factor of the number of rotor poles. Consequently, an alternator with a large number of rotor poles must also have a large number of core slots and therefore a large number of slot segments. A large number of slot segments further increases the stator winding resistance and therefore is an undesirable stator characteristic. Due to the slot segments of the conductors extending the full length of the core, the typical “high slot fill” stator windings are considered to be low resistance stator windings but not super low resistance stator windings.

To increase the output of a machine it is desirable to increase the axial length of the stator core to reduce the reluctance of the flux circuit. Increasing the stator core length of the typical alternator stator, however, is undesirable because it results in longer core slots thereby increasing the stator winding resistance due to an increase in the length of the conductor slot segments.

It is also important that the new stator assembly design of the present invention is mated to a rotor assembly wherein the flux pattern produced by the rotor assembly creates the proper generated voltages in the stator assembly. Furthermore, the rotor must produce a flux which creates generated voltage in the phases of the stator winding which are substantially equal in magnitude but offset by the proper phase angle.

Accordingly, what is needed is a design of a dynamoelectric machine having a rotor assembly featuring a winding having a high “slot fill factor”, a plurality of poles that exhibit minimal bending at high rotational speeds, a plurality of poles that can easily be laminated at the surface of the poles, and a rotor that could potentially have a long axial length yet does not greatly affect the axial flux path. Furthermore a design of a dynamoelectric machine is needed having a stator assembly featuring a super low resistance stator winding, a stator core that could potentially have a long axial length yet does not greatly effect the resistance of the stator winding and a stator/rotor assembly that could potentially have an increased number of poles yet does not greatly affect the resistance of the stator winding.

### BRIEF SUMMARY OF THE INVENTION

A dynamoelectric machine according to the present invention includes a stator assembly having a generally cylindrically-shaped stator core having a plurality of stator ring slots that each encircle one complete revolution around the stator core, are open to the inner diameter of the core and are closed to the outer diameter of the core. The stator ring slots are offset from each other in the axial direction. The stator assembly includes one conductor located within each stator ring slot wherein each conductor encircles at least one complete revolution around the central axis of the core. To achieve a high slot fill factor, the conductor and stator ring slot may both have a generally rectangular or square cross sectional shape. Each conductor will usually encircle around the core a plurality of revolutions to increase the number of electrical turns and thereby the generated voltage in the stator winding.

The stator core includes a yoke which is a ring of magnetic material beginning at the outer surface typically a diameter) and extending inward until reaching the outermost surface of the stator core gap. Axially-adjacent to and just above or below each stator ring slot, the stator core includes a plurality of circumferentially-alternating core teeth and stator core gaps. The core teeth are also formed of magnetic material, are attached to the yoke and extend radially inwards until they reach the inner diameter of the core. The stator core gaps are formed of non-magnetic material (typically air) and beginning at the yoke, the stator core gaps extend radially inward. Each stator ring slot has at least one axially-adjacent stator core portion formed of the circumferentially-alternating core teeth and stator core gaps. The opposite axially-adjacent stator core portion may be similarly formed of circumferentially-alternating core teeth and stator core gaps or this portion may be formed of substantially solid rings (i.e. this portion may not have stator core gaps) that extend radially inward from the yoke to the inner diameter of the stator core. To create a plurality of phases, typically three or six, a different phase angle may be created for each conductor by circumferentially shifting the core teeth axially-adjacent to one stator ring slot with respect to (and by a predetermined amount) the core teeth axially-adjacent to a second stator ring slot and so forth.

A dynamoelectric machine according to the present invention may also include a rotor assembly having a generally cylindrically-shaped rotor pole geometry and rotor core having a plurality of rotor ring slots that each encircle one complete revolution around the rotor core, and opposite of the stator core, are closed to the inner diameter of the rotor core and are open to the outer diameter of the core. The rotor ring slots are also offset from each other in the axial direction. The rotor assembly includes a conductor which is located within the rotor ring slots wherein the conductor encircles a plurality of complete revolutions around the central axis of the rotor core having at least one revolution located in each rotor ring slot. To achieve a high slot fill factor, the conductor and rotor ring slot may both have a generally rectangular or square cross sectional shape. The conductor will usually encircle around the core a plurality of revolutions located in the same rotor ring slot to increase the number of electrical turns and thereby the amount of electromagnetic force produced by the rotor.

The rotor core includes a hub which is a ring of magnetic material beginning at the central axial axis of the rotor core and extending outward until reaching the innermost surface of the rotor gaps. Axially-adjacent to and just above and below each rotor ring slot, the rotor core includes rotor tooth portion—a plurality of circumferentially-alternating rotor teeth and rotor gaps. The rotor teeth are also formed of magnetic material, are attached to the hub and extend radially outwards until they reach the outer diameter of the rotor. The rotor gaps are formed of non-magnetic material (typically air) and beginning at the outer surface of the hub, the rotor gaps extend radially outward. Although the rotor ring slots may have an axially adjacent portion formed of solid rings similarly to the stator assembly, both axially-adjacent portions may include circumferentially-alternating rotor teeth and rotor gaps. Furthermore, to reduce flux leakage from a first rotor tooth portion on one axial side of a certain rotor ring slot to the second rotor tooth portion on the opposite axial side of the same rotor ring slot, the second rotor tooth portion may be circumferentially shifted a predetermined amount from first rotor tooth portion.

Advantageously, the dynamoelectric machine of the present invention includes a rotor and stator assembly featuring a winding having a high “slot fill factor”, a plurality of rotor poles that exhibit minimal bending at high rotational speeds, a plurality of rotor poles that can easily be laminated at the surface of the poles, and a stator/rotor assembly that could potentially have long axial lengths yet does not greatly affect the axial flux path or the stator winding resistance, a stator winding featuring a super low resistance, and a stator/rotor assembly that could potentially have an increased number of poles yet does not greatly affect the resistance of the stator winding.

Additional features, benefits, and advantages of the invention will become apparent to those skilled in the art to which the invention relates from the subsequent description of several exemplary embodiments and the appended claims, taken in conjunction with the accompanying Drawings.

### BRIEF DESCRIPTION OF THE DRAWINGS

In the Drawings, wherein like reference numerals are used to designate like components in each of the several views, and wherein the relative thickness of certain components has been increased for clarity of illustration:

FIG. 1 is a top view of an exemplary stator core constructed in accordance with the invention;

FIG. 2 is a partial view in perspective, partially broken away, of an exemplary stator core of FIG. 1 constructed in accordance with the present invention;

FIG. 3 is a partial view in perspective, partially broken away, of an exemplary stator including a partial stator winding constructed in accordance with the present invention;

FIG. 4 is a partial cross sectional view of an exemplary stator core showing a stator ring slot housing a substantially rectangular conductor in accordance with the present invention;

FIG. 5 is a partial view in perspective of a rotor assembly not including the rotor winding constructed in accordance with the present invention;

FIG. 6 is a partial view in perspective, partially broken away, of a rotor assembly including the rotor winding constructed in accordance with the present invention;

FIG. 7 is a partial cross sectional view of an exemplary rotor core showing a rotor ring slot housing a substantially rectangular rotor conductor in accordance with the present invention;

FIG. 8 is a cross-sectional view of an exemplary stator assembly and rotor assembly in accordance with the present invention;

FIG. 9 is a schematic of a six phase dual wye machine constructed in accordance with the present invention;

### DETAILED DESCRIPTION OF THE PREFERRED EMBODIMENT

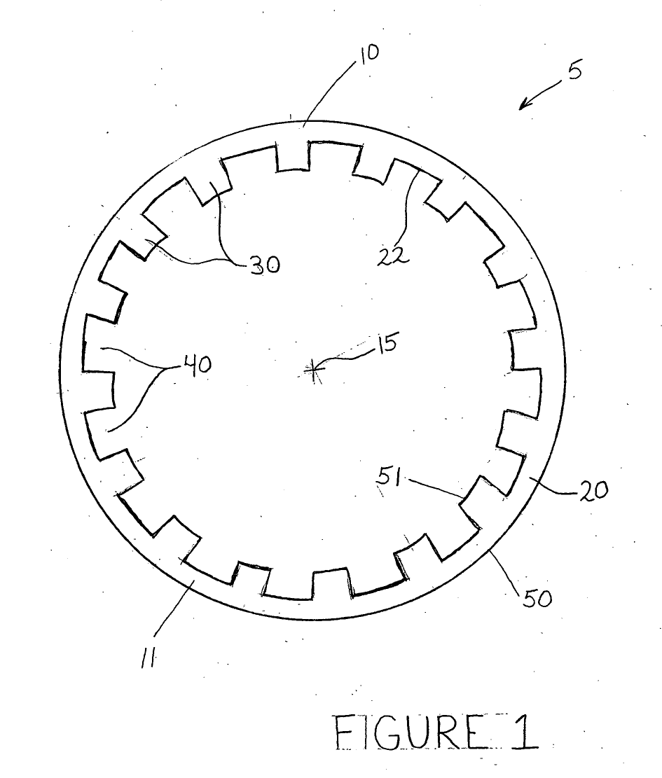

Referring to FIG. 1, a top view of the stator assembly, generally indicated as 5, and more specifically of the stator core 10 of the present invention is shown including a top axial end 11. The stator core 10 is formed of a magnetic permeable material and typically is formed of laminations (not shown). The stator core 10 is a substantially annular member that is defined by an outer diameter 50 and an inner diameter 51. The stator core 10 also includes a yoke 20 which is a ring of material which extends radially from the outer diameter 50 to the yoke inner surface 22. Stator core teeth 30 extend from the yoke 20 in the inward direction toward the center axis 15 of the core but stop short at the inner diameter 51. For clarification, the top view of the stator core 10 only shows the top surface and does not show any lines of lower levels. The plurality of stator core teeth 30 are separated in the circumferential direction by a series of stator core gaps 40. The stator core gaps 40 consist of non magnetic permeable material, typically air.

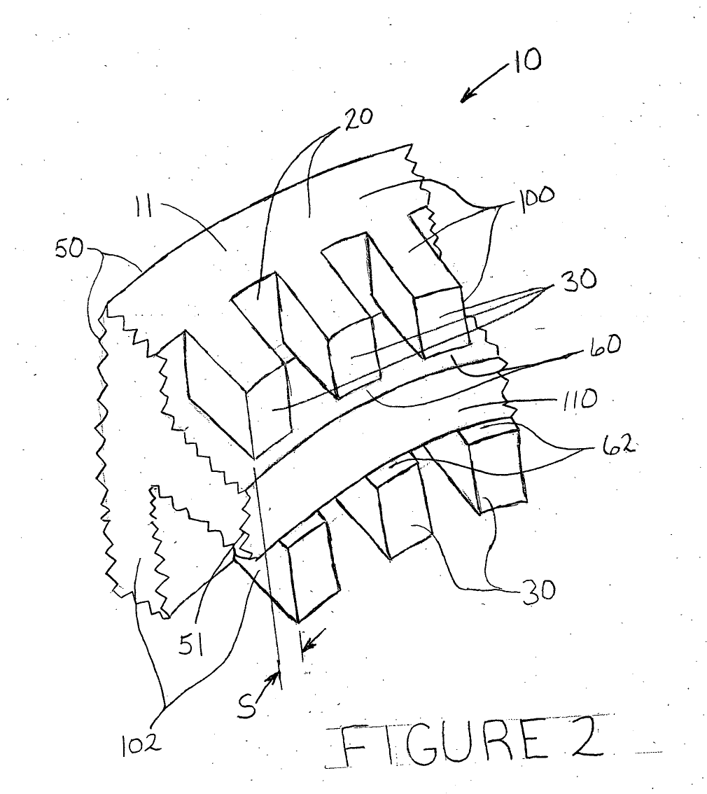

Now referring to FIG. 2, a partial perspective view of the stator core, indicated generally as 10, is shown. In FIG. 2, the top axial end 11 shown in FIG. 1, is the surface closest to the top of the page. The stator ring slot 60, is a slot that begins at the yoke inner surface 22 and extends radially inward. The stator ring slot 60, also extends in the axial direction such that the axial width of a stator ring slot 60, including any insulation, is slightly greater than the axial width of one conductor, including any insulation and described in more detail below. The stator ring slot 60, extends around the core for one substantial revolution around the central axis 15 of the stator core 10. A tooth portion 100 is located on one axial side of the stator ring slot 60. The tooth portion 100 is formed of magnetic material and consists of the three dimensional portion of the stator core, indicated generally as 10, that has the shape of the top axial end 11, including the yoke 20 and a plurality of core teeth 30, and extends axially downward until reaching the stator ring slot 60.

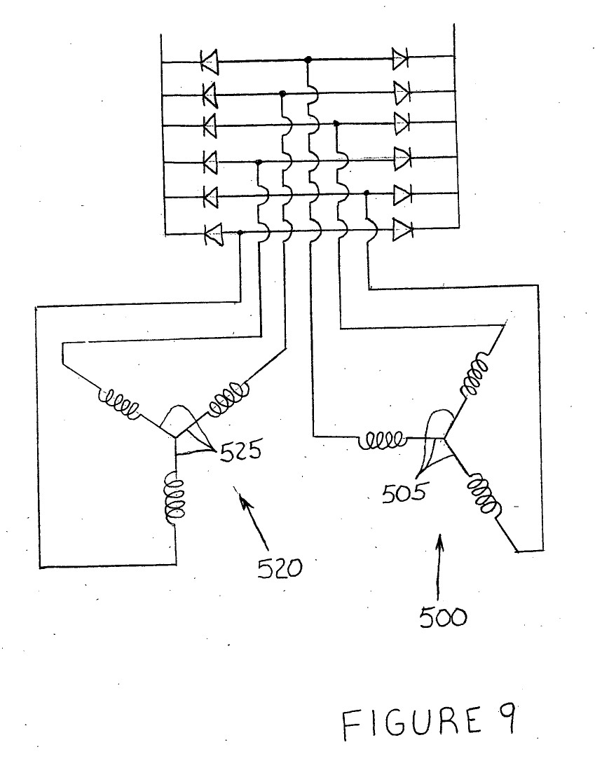

Axially-adjacent to and located on the opposite axial side of the stator ring slot 60, the stator core 10 includes a ring portion 110. The ring portion 110 is a solid ring of material which begins at the outer diameter 50 and extends radially inward until reaching the inner diameter 51. Another stator ring slot 62 is located axially-adjacent to and axially beneath the ring portion 110. The stator ring slot 62 is substantially similar to the stator ring slot 60 except that it is axially shifted from the stator ring slot 60 by a predetermined amount. Axially-adjacent to and axially beneath the stator ring slot 62, the stator core 10 includes a tooth portion 102. The tooth portion 102 is substantially similar to the tooth portion 100 except that tooth portion 102 is circumferentially shifted a predetermined amount. In FIG. 2, the circumferential shift is shown as the letter S. The flux produced by the rotor will enter a core tooth 30 of the tooth portion 100, travel radially outward down the core tooth 30, travel axially downward through the yoke 20, travel radially inward through the ring portion 110 and back to the rotor. As can be seen, the path of the flux encircles the stator ring slot 60 and therefore any conductors located in the stator ring slot 60 will be induced with a generated voltage potential which therefore generates an electrical current which is channeled to the battery for charging. To achieve the phase angle shift to create different phases (typically three or six phases), the tooth portion 102 is circumferentially shifted a predetermined number of degrees from the tooth portion 100, thereby allowing the conductors in stator ring slot 62 to be induced with a generated voltage by the rotor flux at a different point in time than the conductor disposed in the stator ring slot 60 (thereby creating a different phase angle for each conductor). For a three phase machine, it is commonly known that the tooth portion 102 would be shifted 120 electrical degrees and for a six phase machine, the tooth portion 102 would be shifted 30, 120 or 150 electrical degrees. A six phase machine, otherwise known as a dual wye machine is shown in FIG. 9. Although described as a three phase or six phase machine, it is commonly known to those skilled in the art that a nine phase (tri wye/delta) or twelve phase (quad wye/delta) and so forth winding could be produced.

Although the stator core 10 is shown in FIG. 2 having a tooth portion 102 circumferentially shifted from the tooth portion 100 to create two conductors, 60 and 62, having different phase angles, it is understood by those skilled in the art that the stator might have a plurality of tooth portions that are not shifted circumferentially from each other and that the conductors might have different phase angles created by the rotor tooth portions being circumferentially shifted similarly to the stator core 10 shifting shown in FIG. 2. Although the ring portion 110 is shown as a solid ring it may in fact have the same toothed shape as the ring portion 100 and may be circumferentially shifted from the ring portion 100 such that it matches a shift found in the rotor poles.

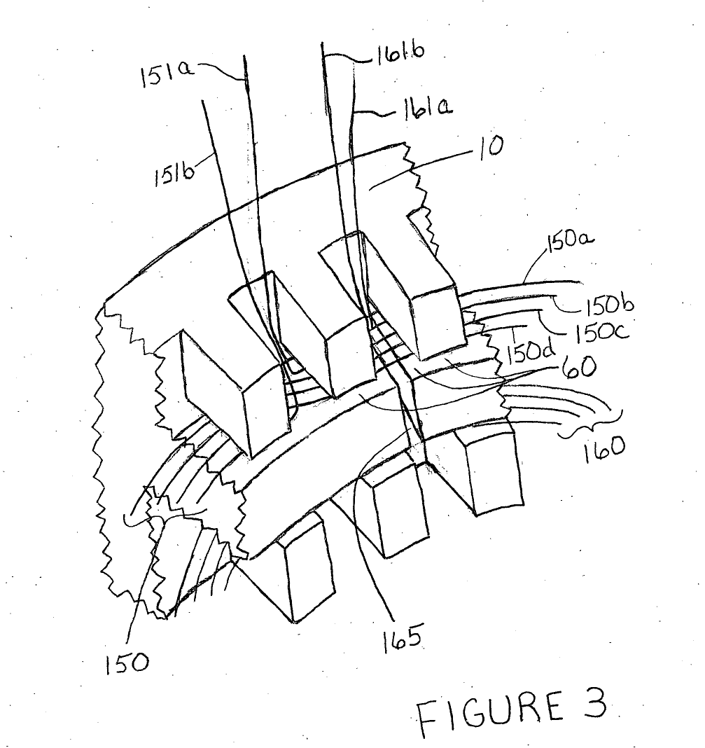

Now referring to FIG. 3, a partial perspective view of the stator core 10 showing the stator ring slot 60 and further including a conductor 150 disposed within the stator ring slot 60. Not shown is an insulator that may be placed in between the sides of the stator ring slot 60 and the conductor 150 to electrically isolate the conductor 150 from the sides of the stator ring slot 60. The conductor 150 may further be considered an insulated conductor in that the conductor 150 may have a layer of insulation (not shown) covering the outside of the conductor 150. The conductor 150 makes a plurality of passes around the revolution of the stator core 10 located in the stator ring slot 60 as shown in FIG. 3 as a four pass conductor—a first pass 150a, a second pass 150b, a third pass 150c and a fourth pass 150d. A plurality of passes, are needed because each pass creates an electrical turn and the generated voltage of the conductor is equal to the number of electrical turns times the rate in change of flux. Therefore, to increase the generated voltage, the number of electrical turns or circumferential passes may be increased—typically between four and six.

Again referring to FIG. 3, a partial cross-sectional view of the stator core 10 and more specifically of the stator ring slot 60 is shown including leads 151a and 151b of the conductor 150. As can be seen the leads 151a and 151b exit the stator ring slot 60 in the axial direction through a core gap 40. The leads 161a and 161b of the conductor 160 located in the stator ring slot 62, exit axially but must pass through a localized slot 165 in the ring portion 110 to be able to exit the stator core 10. Therefore, localized axial slots, such as 165 in the stator ring portions, such as 60, may be required to allow the leads, such as 151a, to exit the stator core 10. Even with localized axial slots, these ring portions, such as 110, are still considered to be substantial ring portions. It may also be desirable to wind the conductors located in the lowest ring slots first, so that the passes of the uppermost conductor 150 traps the leads, such as 161a and 161b, of the other conductors, such as 160 as shown.

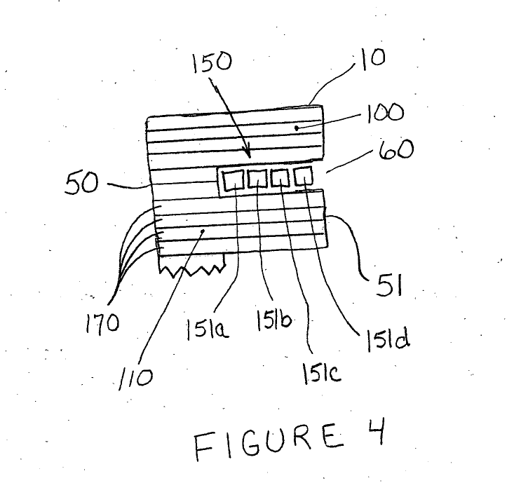

Now referring to FIG. 4 a partial cross-sectional view of the stator core 10 and more specifically of the stator ring slot 60 is shown. Disposed inside the stator ring slot 60 is a series of circumferential passes 151a, 151b, 151c and 151d of the conductor, generally indicated as 150. As can be seen, the conductor, generally indicated as 150, has a substantially rectangular cross section. As is known to those skilled in the art, a square cross-sectional shape is just another type of a rectangular cross-sectional a slot and that the conductor, generally indicated as 150, may also have an elliptical or round cross sectional shape. It is also known to those skilled in the art that a rectangular cross-sectional shape may include a radius on the corners between two adjacent sides, yet is still considered to have a rectangular cross-sectional shape. To further maximize the slot fill factor, the circumferential passes, 151a, 151b, 151c and 151d of the conductor, generally indicated as 150, are arranged in one substantial radial row within the stator ring slot 60 and the axial width of the conductor, generally indicated as 150, including any insulation, fits closely to the axial width of the stator ring slot 60, including any insulation. To accomplish the close fit, the stator ring slot 60 has a substantial constant axial width for the radial length (from the stator core inner diameter 51 to the outermost portion of the stator ring slot 60) of the stator ring slot 60. To reduce any eddy current losses on the stator core 10, the tooth portion 100 and the ring portion 110 are shown laminated with a plurality of laminations 170.

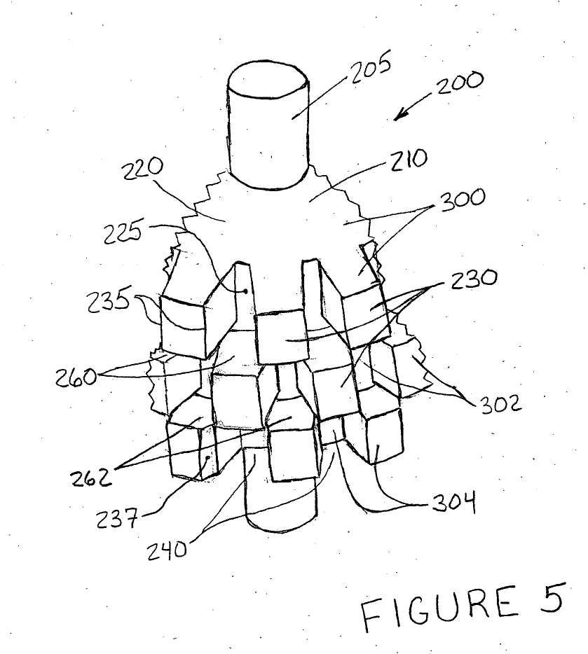

Now referring to FIG. 5, a partial perspective view of a rotor assembly, generally indicted as 200, is shown with a shaft 205 and a rotor core 210 fixed to the shaft 205. The shaft 205 is typically formed of a magnetic material, typically steel, and supports the rotor assembly by bearings (not shown) mounted on each end of the shaft 205. The rotor core 210 includes rotor tooth portions 300, 302 and 304 which are disposed in the axial direction separated by rotor ring slots 260 and 262. The rotor core 210 includes a hub 220 which begins at the outer diameter of the shaft 205 and extends radially outward until reaching the hub outer surface 225. The hub 220 also extends the full axial length of the rotor core 210 and is formed of a magnetic material. The rotor tooth portion 300 includes a portion of the hub 220 and a plurality of rotor teeth 230 which are all disposed at the same axial location. The rotor teeth 230 are separated in the circumferential direction by a plurality of rotor gaps 240. The rotor teeth 230 are formed of magnetic material and begin at the hub outer surface 225 and extend radially outward until reaching the rotor outer diameter 250. The rotor gaps 240 are formed of a non-magnetic material, typically air, and begin at the hub outer surface 225 and extend radially outwards. If necessary, the rotor gaps 240 may even be filled with permanent magnets to further increase the electromagnetic force produced by the rotor assembly 200.

A second rotor tooth portion 302 is substantially similar to rotor tooth portion 300 yet located axially below the rotor tooth portion 300 and separated by a rotor ring slot 260. In other words, the rotor tooth portion 300 is located on one axial side of the rotor ring slot 260 and the rotor tooth portion 302 is located on the opposite axial side of the rotor ring slot 260. In FIG. 5, the rotor tooth portions 300 and 302 are shown axially-adjacent to the rotor ring slot 260. The rotor ring slot 260 is a slot formed in the rotor core 210 which begins at the hub outer surface 225 and extends radially outward. The rotor ring slot 260 has an axial width, including any insulation, which is just slightly larger than the axial width, including any insulation, of the rotor conductor, described in more detail below. The rotor ring slot 260 extends circumferentially around the rotor core 210 for one substantial revolution. The rotor tooth portion 302 is shown circumferentially shifted from the rotor tooth portion 300 to minimize any flux leakage across one rotor teeth 230 located on rotor tooth portion 300 and one rotor teeth 230 located on rotor tooth portion 302. Similar to rotor tooth portion 302 and rotor ring slot 260, a rotor tooth portion 304 is positioned axially below rotor tooth portion 302 separated by a rotor ring slot 262.

The rotor teeth portions 230 each include two rotor tooth corners 235. As the rotor assembly 200 rotates in the stationary stator core 10, these rotor tooth corners 235 are the transitions between a stator core tooth 30 being energized with flux and not being energized with flux. Sharp flux transitions can create loud electromagnetic noise levels which is undesirable in the operation of dynamoelectric machines. Therefore it might be desirable to add chamfers to all of the rotor tooth corners 235 as can be seen as the rotor chamfer 237 in FIG. 5 (only shown on one rotor tooth corner for simplicity).

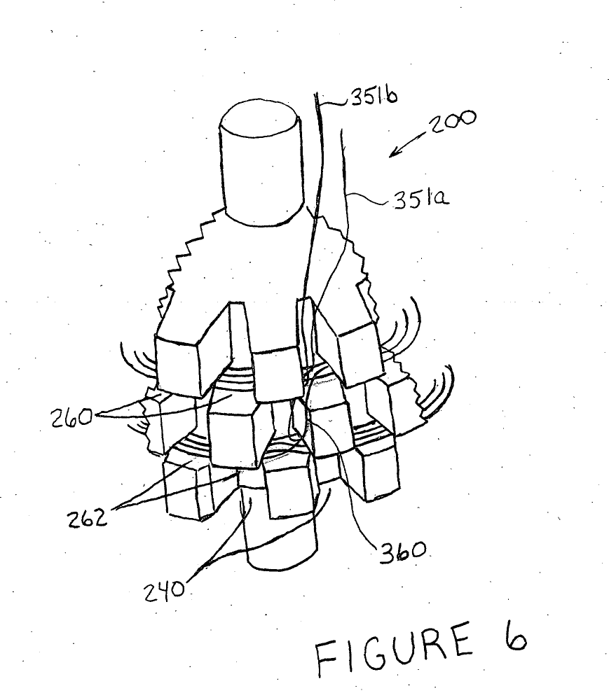

Now referring to FIG. 6, a partial perspective view of a rotor assembly 200 is shown including a rotor conductor 350. Not shown is an insulator that may be placed in between the sides of the rotor ring slot 260 and the rotor conductor 350 to electrically isolate the rotor conductor 350 from the sides of the rotor ring slot 260. The rotor conductor 350 may further be considered an insulated conductor in that the rotor conductor 350 may have a layer of insulation (not shown) covering the outside of the rotor conductor 350. The rotor conductor 350 makes a plurality of passes around the revolution of the rotor core 210 located in the rotor ring slot 260 as shown in FIG. 5 as having a plurality of passes—a first pass 350a, a second pass 350b, a third pass 350c. A rotor conductor 350 having three passes, such as 350a, 350b, etc., per rotor ring slot 260 is shown only for simplicity. In actuality the number of passes, such as 350a, per rotor ring slot 260 should be much greater. A plurality of passes are needed because each pass, such as 350a, creates an electrical turn and the electromagnetic force is equal to the number of electrical turns times the electrical current. Therefore, to increase the amount of electromagnetic force, the number of electrical turns or rotor passes, such as 350a, of the rotor conductor 350 must be increased. The typical “claw pole” rotor assembly has 300 electrical turns. The rotor assembly 200 of the present invention may have six to twelve rotor ring slots, such as 260, and therefore will need 25 to 50 electrical turns or passes, such as 350a, of the rotor conductor 350 per each rotor ring slot, such as 260.

The rotor conductors, such as 350 located in each rotor ring slot, such as 260, could be of the rotor assembly 200 could be connected to each other in parallel or in series. Because a series connection seems most likely, the series connection is shown in FIG. 6. The rotor conductor 350 is wound beginning in the lowest axial rotor ring slot 262, with a lead 351a extending axially through the rotor gaps 240 and out the top axial end of the rotor core 210. After completing the desired number of revolutions around the rotor core 210 located in the ring slot 262, the rotor conductor 350 is crossed through a rotor gap 240 thereby forming a crossing portion 360. The rotor conductor 350 is then wound the desired number of revolutions around the rotor core 210 located in the rotor ring slot 260. Finally, the rotor conductor 350 is finished to form a second lead 351b which extends through a rotor gap 240 of the rotor tooth portion 300 and exits out the top axial end of the rotor core 210. In this winding method, the rotor lead 351a, which must travel the complete axial length of the rotor core 210, is trapped behind the revolutions of the rotor conductor 350. It might also be desirable to wind the conductors, such as 350, such that the revolutions wound in one rotor ring slot 260 are wound in the counter clockwise direction and the revolutions wound in the adjacent rotor ring slot 262 are wound in the clockwise direction and so forth thereby alternating winding directions in every rotor ring slot.

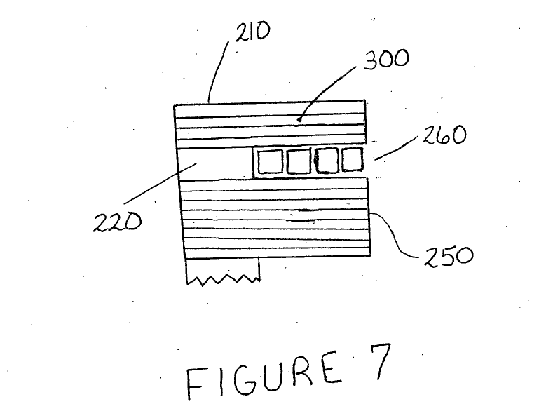

Now referring to FIG. 7, a partial cross-sectional view of the rotor core 210 and more specifically of the rotor ring slot 260 is shown. Disposed inside the rotor ring slot 260 is a series of circumferential passes of the rotor conductor 350. As can be seen, the rotor conductor 350 has a substantially rectangular cross section. The rotor conductor 350 may, however, also have a substantially elliptical or round cross-sectional shape. It is known to those skilled in the art that a rectangular cross-section may include a radius on the corners between two adjacent sides, yet is still considered to be a rectangular cross-section. To further maximize the slot fill factor, the circumferential passes of the rotor conductor 350 are arranged in one substantial radial row within the rotor ring slot 260 and the axial width of the rotor conductor 350, including any insulation, fits closely to the axial width of the rotor ring slot 260, including any insulation. To accomplish the close fit, the rotor ring slot 260 has a substantial constant axial width for the radial length (from the rotor outer diameter 250 to the innermost portion of the rotor ring slot 260) of the rotor ring slot 260. It is possible that

To reduce any eddy current losses on the surface located at the rotor outer diameter 250, the rotor tooth portions, such as 300, may be laminated as can be seen in FIG. 7. Laminations, however, can be detrimental to the flow of the flux and therefore it may be desirable to have the rotor tooth portions, such as 300, be formed of laminations but the portion of the hub 220 located radially inward from the rotor ring slots, such as 260, to be formed of thicker laminations or one solid member—i.e, not formed from laminations.

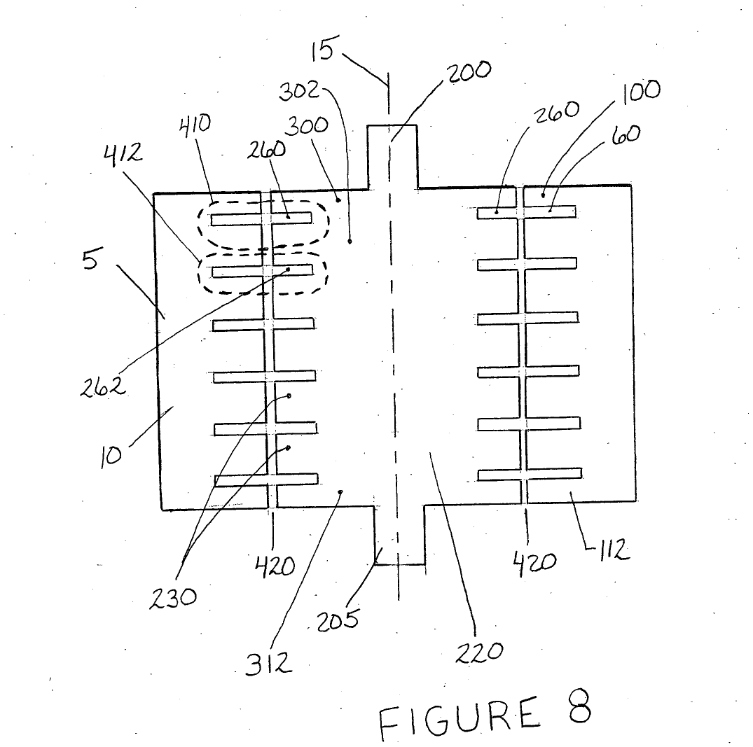

Now referring to FIG. 8, a cross sectional view of the rotor assembly 200 and the stator assembly 5 is shown. As can be seen in FIG. 8, there exists an equal amount of rotor ring slots, such as 260 as there exists stator ring slots, such as 60 and the rotor ring slot 260 is at substantially the same axial location as the stator ring slot 60. Same is true for rotor ring slot 262 and stator ring slot 62 and so forth. The stator leads, such as 151a best seen in FIG. 3, exit the stator assembly axially in the same direction. The stator leads are connected to a rectifier bridge as is commonly known to those skilled in the art and described as connected in a dual wye winding below. The stator core 10 of the stator assembly is mounted to a front housing (not shown) on one axial end and to a rear housing (not shown) on the opposite axial end which is common to those skilled in the art. Each housing includes a bearing (not shown) to which the inner diameter is attached to the shaft 205 of the rotor assembly 200. The bearing and housing assemblies locate the stator core 10 and the rotor assembly 200 concentric to each other and on the same central axis 15. The bearings allow the rotor assembly 200 to spin while the stator assembly 5 remains stationary. The flux path of the present invention is shown in FIG. 8 as flux path 410 At a particular point in time, as the rotor teeth 230 rotate by the stationary core teeth 30 of the stator core 10, the flux produced by the rotor conductor 350 passes from the hub 220 to a rotor tooth 230 of rotor tooth portion 300, across the air gap 420, through a stator core 10 as previously described, back into a rotor tooth 230 of rotor tooth portion, radially inward until it returns to the hub 220. As shown, the flux path 410 encircles the stator conductor 150 thereby generating a voltage in the stator conductor 150. A second and similar flux path 412 is shown around the rotor ring slot 262. As can be seen, the rotor tooth portion 300 only carries one flux path while the rotor tooth portion 302 carries two flux paths. Therefore to keep the flux densities of the rotor material consistent, the axial width of the rotor tooth portion 300 may be substantially half of the axial width of the “middle” tooth portions, such as 302. Similarly, the rotor tooth portion 312 may also have half of the axial width as the “middle” rotor tooth portions, such as 302. Same is true for the stator tooth portions 100 and 112.

For simplicity, the figures, such as FIG. 1 and FIG. 2, show a stator core 10 having only two stator ring slots 60 and 62. However, it is easily understood that any number of tooth portions, such as 100, alternating axially with ring portions, such as 110, separated by a stator ring slot, such as 60, could be combined to create a stator core 10 having any number of stator ring slots. Since the desired number of phases in a stator assembly 5 is usually a factor of three and each stator ring slot, such as 60, may house a conductor being its own distinct phase, it is easily understood that the number of desired stator ring slots, such as 60, may likely be equal to three, six, nine, etc in the stator assembly 5. For a six phase winding, the conductors of each phase are connected to each other in either a dual wye winding or a dual delta winding. Now referring to FIG. 9, A dual wye winding is shown having a first wye winding, generally indicated as 500, and a second wye winding, generally indicated as 520. The first wye winding 500 includes three phases 505 wherein one lead of each phase 505 is connected together such that each phase 505 is shifted 120 electrical degrees from another phase 505. The second wye winding 520 includes three phases 525 wherein one lead of each phase 525 is connected together such that each phase 525 is shifted 120 electrical degrees from another phase 525. The connection results in the first wye winding 500 being shifted 30 electrical degrees from the second wye winding 520. The opposite lead of each phase 505 and 525 are each connected to two switching elements such that the current is rectified from AC current to DC current.

The design of the stator assembly 5 and the rotor assembly 200 result in a dynamoelectric machine design wherein increasing number of poles does not detrimentally affect the stator resistance. Therefore, it is natural to design a dynamoelectric machine of the present invention with a very large number of poles. This is an important point because the relatively few number of rotor electrical turns in each rotor ring slot, such as 60, of the present invention generates a lower electromagnetic force and therefore magnetic flux in the stator. The generated stator voltage is proportional to the rate in change of flux and therefore, to compensate for the lower electromagnetic force and lower flux, the number of poles should be greatly increased in any design of the present invention. The typical “claw pole” rotor assembly includes six or eight north poles, therefore a large number of poles for an alternator design of the present invention would be any number greater than sixteen. Referring back to FIG. 2, the number of poles is equal to the number of core teeth 30 located on one ring portion, such as 100. FIG. 1 shows a stator assembly 5 having sixteen core teeth 30.

One potential negative aspect of the present invention is that the stator voltage induced in the stator conductors 150 fluctuates between zero and positive not negative and positive as found in the “claw pole” design. This effect reduces the voltage potential induced in the stator conductors 150. One possible solution would be to create mini-fingers on the rotor similar to the “claw-pole” design but each rotor ring slot, such as 260, would have its own set of alternating mini north and south fingers. In this design, each rotor ring slot would be created by poles that would be forged and assembled as a stacked “claw-pole” rotor except the area for the rotor conductor would be very axially narrow and the fingers would be very short.

While the above description constitutes the preferred embodiment, it will be appreciated that the invention is susceptible to modification, variation and change without departing from the proper scope and fair meaning of the subjoined claims.

What is claimed is:

1. A dynamoelectric machine, comprising:
a stator assembly having a generally cylindrically-shaped stator core having a plurality of stator ring slots wherein each stator ring slot extends circumferentially around said stator core for one substantial revolution;
at least one conductor that is disposed in one of said stator ring slots, said at least one conductor extends circumferentially around the core for at least one substantial revolution; and
said stator core further includes at least one tooth portion which is located on one axial side of said stator ring slot, said tooth portion including at least sixteen core teeth.

2. A dynamoelectric machine, comprising:
a stator assembly having a generally cylindrically-shaped stator core having at least six stator ring slots wherein each stator ring slot extends circumferentially around said stator core for one substantial revolution;
at least one conductor that is disposed in each one of said stator ring slots, said at least one conductor extends circumferentially around the core for at least one substantial revolution; and
said stator core further includes at least one tooth portion which is located on one axial side of said stator ring slot.

3. The dynamoelectric machine according to claim 2 wherein said stator core includes at least one stator ring slot being open to the inner diameter of said stator core and having a substantially constant axial width along the radial length of said stator ring slot.

4. The dynamoelectric machine according to claim 3 wherein at least one of said conductors has a substantially rectangular cross-sectional shape.

5. The dynamoelectric machine according to claim 2 wherein said stator core is comprised of a plurarity of laminations.

6. The dynamoelectric machine according to claim 2 wherein said stator core includes a stator ring slot having a first tooth portion located on one axial side of said stator ring slot and a second tooth portion located on the opposite axial side of said stator ring slot.

7. The dynamoelectric machine according to claim 2 wherein said stator core includes a stator ring slot having a tooth portion located on one axial side of said stator ring slot and a ring portion located on the opposite axial side of said stator ring slot.

8. The dynamoelectric machine according to claim 2 wherein a portion of said conductor disposed in one of said stator ring slots, includes a plurality of passes around the revolution of the stator core and said passes are aligned in one radial row in at least one of said stator ring slots.

9. The dynamoelectric machine according to claim 2 wherein each one of said conductors disposed in a first stator ring slot have a phase angle different than the phase angle of the rest of the conductors disposed in a second stator ring slot.

10. The dynamoelectric machine according to claim 2 further including a rotor assembly having a plurality of rotor ring slots which each pass circumferentially around said rotor assembly for one substantial revolution and having a rotor conductor disposed in a plurality of said rotor ring slots.

11. The dynamoelectric machine according to claim 10 wherein said rotor assembly includes at least one said rotor conductor having a substantially rectangular cross-sectional shape.

12. The dynamoelectric machine according to claim 10 wherein a portion of said rotor conductor disposed in one of said rotor ring slots, includes a plurality of passes around the revolution of the rotor core and said passes are aligned in one radial row in one of said rotor ring slots.

13. A dynamoelectric machine, comprising:
a stator assembly having a generally cylindrically-shaped stator core;
a rotor assembly having a generally cylindrical-shape and having a plurality of rotor ring slots wherein each rotor ring slot extends circumferentially around said rotor assembly for one substantial revolution;
at least one rotor conductor that is disposed in one of said rotor ring slots, said at least one rotor conductor extends circumferentially around the core for at least one substantial revolution; and
said rotor assembly further including at least one rotor tooth portion which is located on one axial side of said rotor ring slot, said rotor tooth portion including a plurality of rotor teeth separated by plurality of rotor gaps.

14. The dynamoelectric machine according to claim 13 wherein said stator core includes plurality of conductors disposed in a plurality of stator ring slots wherein each stator ring slot and each conductor extends circumferentially around said stator core for at least one substantial revolution.

15. The dynamoelectric machine according to claim 14 wherein said stator core further includes at least one tooth portion which is located on one axial side of said stator ring slot, said tooth portion including a plurality of core teeth separated by a plurality of core gaps; and

16. The dynamoelectric machine according to claim 15 wherein said stator assembly includes a certain number of said stator ring slots having said stator conductor disposed in said stator ring slots and said rotor assembly includes the same number of said rotor ring slots having said rotor conductor disposed in said rotor ring slots.

17. The dynamoelectric machine according to claim 16 wherein each rotor ring slot having a rotor conductor disposed in said rotor ring slot is located at an axial location which is substantially equal to the axial location of a stator ring slot having a stator conductor disposed within said stator ring slot.

18. The dynamoelectric machine according to claim 17 wherein the number of stator ring slots is at least equal to six.

19. The dynamoelectric machine according to claim 15 wherein said stator core includes a plurality of said tooth portions, wherein said tooth portions are shifted in the circumferential direction from each other.

20. The dynamoelectric machine according to claim 15 wherein said rotor assembly includes a plurality of said rotor tooth portions, wherein said rotor tooth portions are shifted in the circumferential direction from each other.
